(19) United States
(12) Patent Application Publication
(10) Pub. No.: US 2012/0064946 A1
(43) Pub. Date: Mar. 15, 2012

(54) RESIZABLE FILMSTRIP VIEW OF IMAGES

(75) Inventors: Eric Voetberg, Seattle, WA (US); Donald A. Barnett, Monroe, WA (US); Tracy Ard, Sammamish, WA (US); Peter Giffin, Redmond, WA (US); Tirthankar Sengupta, Redmond, WA (US); Veronica Y. Law, Seattle, WA (US)

(73) Assignee: Microsoft Corporation, Redmond, WA (US)

(21) Appl. No.: 12/878,880

(22) Filed: Sep. 9, 2010

(51) Int. Cl. H04B 1/38; G09G 5/377

(52) U.S. Cl. 455/566; 345/634; 345/684

(57) ABSTRACT

A method and apparatus are disclosed for allowing sizing adjustment of a filmstrip view, wherein multiple images are displayed simultaneously on a touch screen. In one embodiment, a user can scale images down in a filmstrip view in order to increase a number of visible images. In another embodiment, the scaling of a filmstrip view can be dynamically modified based on scrolling speed. For example, the faster a user flicks a touch screen (i.e., the faster the gesture speed), the smaller the image size of the filmstrip so that more images appear on a single screen. By reducing the size of the images, the user can customize the filmstrip view and scroll through more images at a higher speed without dropping images or information. Additionally, the resolution can remain constant.

### FIELD

The present invention relates to scrolling and, more particularly, to scrolling of images in a user interface.

### BACKGROUND

Digital media has had tremendous success in recent years, which has impacted all age groups. Digital photography, for example, has practically replaced its analog counterpart.

Viewing photos has become easy using touch-screen devices, such as mobile phones. For example, a filmstrip view where multiple images can be viewed simultaneously allows users to navigate through large collections of photos relatively easily. When viewing the filmstrip, a user performs a flick operation wherein the user drags a finger across the touch screen indicating a direction of desired movement. In response, the images scroll across the screen and appear much like a filmstrip. The faster the flick movement, the faster the images scroll. The images can also be expanded through individual selection of a photo on the filmstrip. Once the single image is being viewed, a user can zoom in using an expand command (by moving a forefinger and thumb in opposite directions away from one another on the touch screen.) Conversely, a user can zoom out using a pinch command wherein the forefinger and thumb are dragged until touching. Double tapping on the image can allow a return to the filmstrip view.

Methods of scrolling images at high speeds are discussed in U.S. Pat. No. 7,034,839. The focus of this patent is on maintaining resolution while scrolling the images. Other patents, such as JP-A-H11-161158 reduces resolution to increase scrolling speed. While these patents are directed to increasing scrolling speed, an increased speed does not necessarily assist the user to quickly navigate through a multitude of photographs.

### SUMMARY

A method and apparatus are disclosed for allowing sizing adjustment of a filmstrip view, wherein multiple images are displayed simultaneously on a touch screen.

In one embodiment, a user can scale images down (reducing image size) in a filmstrip view in order to increase a number of visible images. After the user scales the images, the images can be flicked and the scaling remains constant regardless of flicking speed.

In another embodiment, the scaling of a filmstrip view can be dynamically modified based on scrolling speed. For example, the faster a user flicks a touch screen (i.e., the faster the gesture speed), the smaller the image size of the filmstrip so that more images appear on a single screen.

In another embodiment, a transition is made from viewing a single-image viewing mode to a filmstrip viewing mode through a single pinch operation. Using a single command, the user can switch modes and simultaneously resize the multiple images in the filmstrip view. Alternatively, the transition can be made from a single image to a filmstrip view through a scrolling flick command based on scrolling speed.

In yet another embodiment, date markers can be associated with the photos in a filmstrip view, so that while flicking, the user can easily see the month or year associated with the filmstrip of photos.

By modifying the size of the images, the user can customize the filmstrip view and scroll through more images at a higher speed without dropping images or information. Additionally, the resolution can remain constant.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile device that can be used for resizing a filmstrip according to one embodiment.

FIG. 2 is flowchart of a method for resizing a filmstrip view based on user input.

FIG. 3 is a flowchart of a method for entering and resizing a filmstrip view.

FIG. 4 is a diagram illustrating entering and resizing the filmstrip view using a pinch command.

FIG. 5 is a diagram illustrating resizing the filmstrip of FIG. 4 during the same pinch command.

FIG. 6 is a diagram illustrating resizing the filmstrip using a second pinch command after the filmstrip view was already entered.

FIG. 7 is a diagram illustrating flicking the resized filmstrip.

FIG. 8 is a flowchart illustrating resizing using a pinch command.

FIG. 9 is a diagram illustrating entering a filmstrip view using a flick command.

FIG. 10 is a diagram illustrating the filmstrip view as entered using the flick command.

FIG. 11 illustrates dynamic resizing based on scrolling speed.

FIG. 12 is a flowchart of a method for resizing a filmstrip based on scrolling speed.

FIG. 13 is diagram illustrating a date marker scrolling at a slower speed than a filmstrip.

FIG. 14 is a diagram illustrating integrating a date marker in a filmstrip.

FIG. 15 is a flowchart of a method for scrolling the date marker at a different speed than the filmstrip.

FIG. 16 is a system diagram that can be used for implementing various embodiments described herein.

FIG. 17 is a diagram showing different interfaces in which the embodiments described herein can be used.

### DETAILED DESCRIPTION

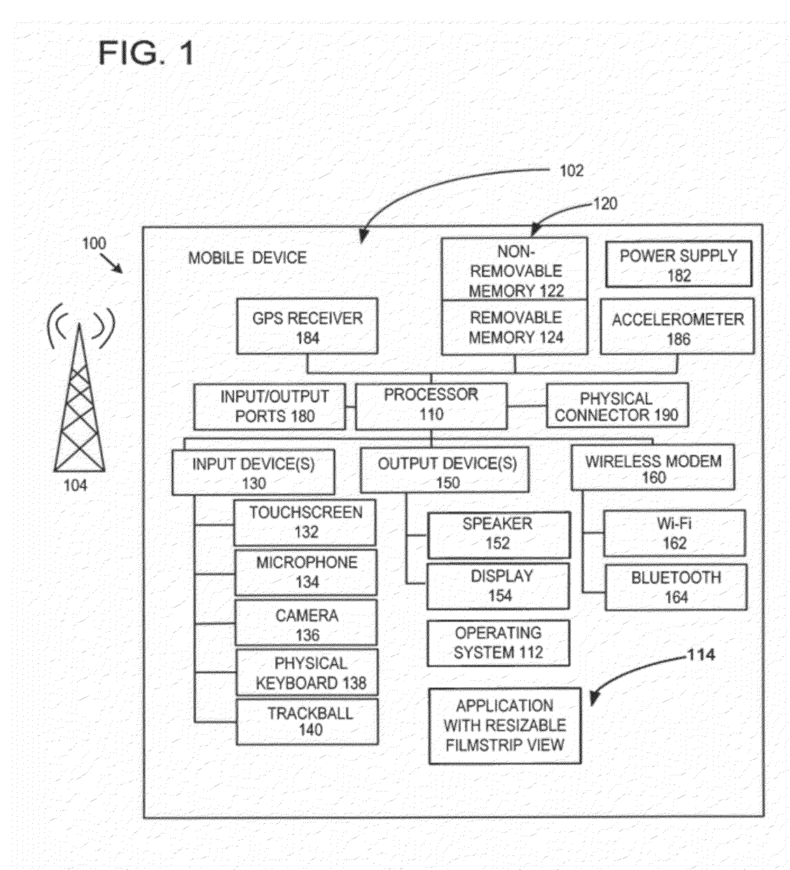

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114, including an application for resizing a filmstrip. The application programs can also include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added. The mobile device of FIG. 1 can be used for viewing images, such as a filmstrip view of multiple images.

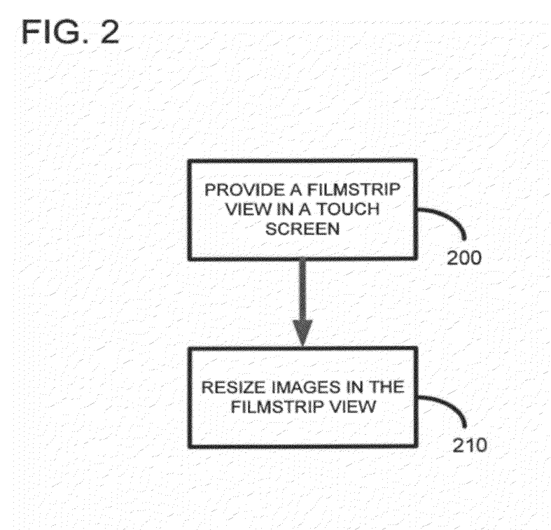

FIG. 2 is a flowchart of a method for resizing a filmstrip. In process block 200, a filmstrip view is provided in a touch screen. An example touch screen can be touch screen 132 in a mobile device, such as a mobile phone. A filmstrip view is a series of independent images (at least two images) that are simultaneously viewable and individually selectable. Upon selection of an image, the user interface switches from a filmstrip viewing mode to a single-image viewing mode. The filmstrip viewing mode can have a single row of images (as illustrated and described below) or multiple rows of images. For example, a single row of photos can be envisioned as the stereotypical filmstrip view, but for purposes of this application, an array of images, with multiple rows and columns can also be used. In process block 210, the images in the filmstrip view can be resized. By resizing, the physical dimensions of each image can be reduced or expanded. The resizing can be typically a global resizing meaning that each image in the filmstrip is changed simultaneously as a group. For example, when reduced, the result is normally a greater number of photos added to the display in order to fill out the viewable area thereof. In a simple example, if a filmstrip includes 5 photos, a global reduction in size can allow 8 photos to fit in the viewable area. Likewise, when enlarged, less photos fit in the filmstrip view. The resizing can be in response to user input or based on a parameter associated with the images. For example, regarding the user input, the resizing can be in response to a pinch command or a flick command, as further described below. Regarding the parameter, an example can be changing the size of the filmstrip based on the number of images to be scrolled in a collection. For example, a greater number of photos in an album, the smaller the photos in the filmstrip view. The scaling and speed can be throttled in order to ensure the images are recognizable and easy to select.

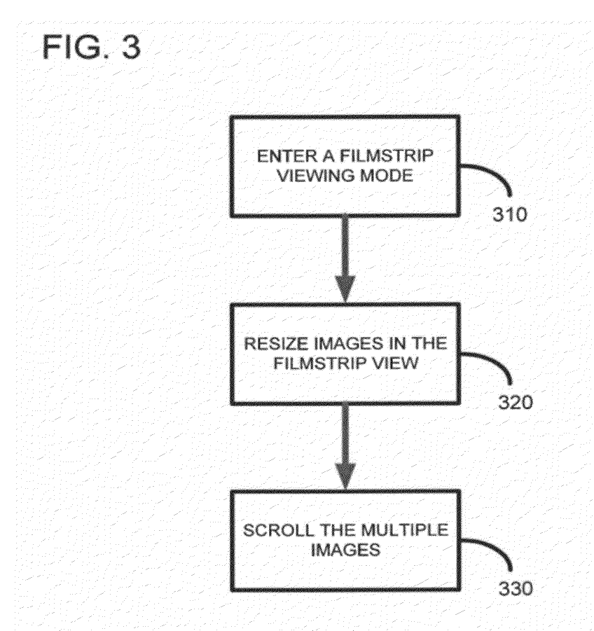

FIG. 3 shows a flowchart of a method incorporating further details that can be implemented. In process block 310, a filmstrip viewing mode can be entered. There can be multiple ways to enter a filmstrip viewing mode. For example, a user can implement a user interface command that switches the user interface from a single-image viewing mode to the filmstrip viewing mode. One such exemplary command can be a pinch command. A pinch command is intuitive because the user is making a motion indicative of reduction. Another possible command is a flick command, which can indicate the desire to scroll. Another potential technique for entering the filmstrip mode is automatically entering that mode based as part of a slideshow. For example, the filmstrip view can be used as a transition between images displayed in the digital photo frame and/or a slideshow. In process block 320, the images can be resized in the filmstrip view. The resizing can be accomplished in a variety of ways, as further described below, but generally requires user input. When resizing, there can be a simultaneous global resizing of all images in the filmstrip. In process block 330, the user can then scroll the images using a standard flick operation or some other scrolling command.

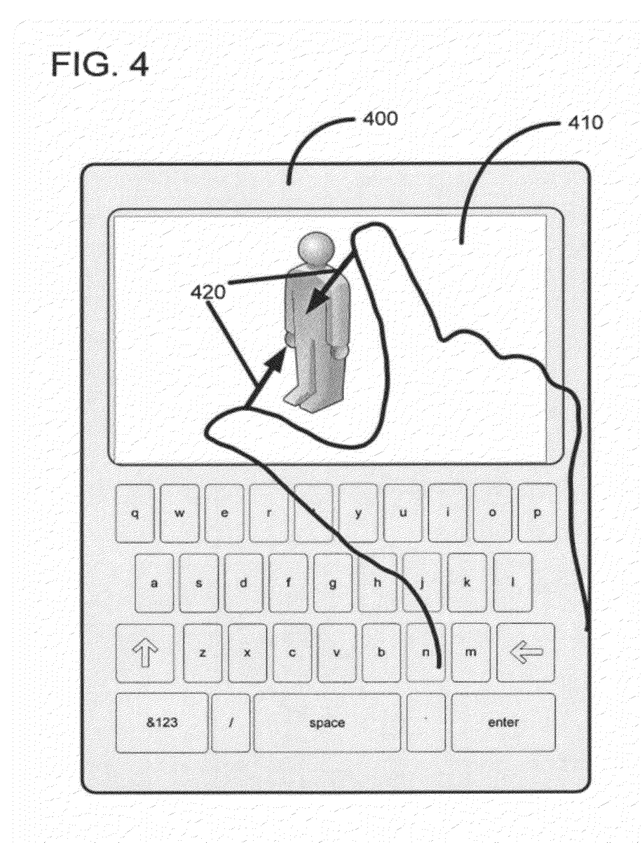

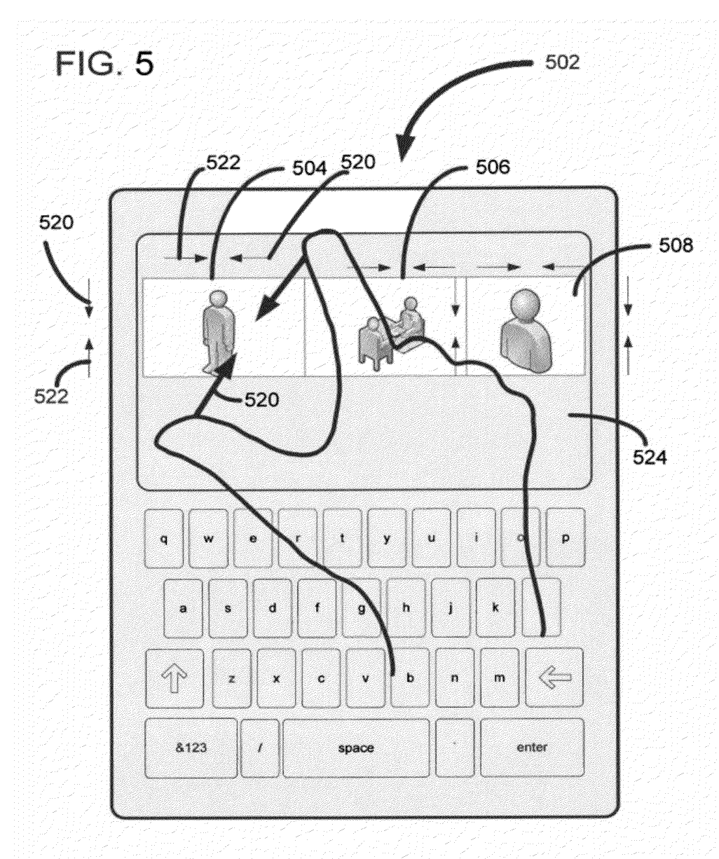

FIG. 4 shows a mobile device 400 with a viewable area 410. An image of a person is currently being displayed in a single-image viewing mode. The single-image viewing mode is where only one image is displayed. The user can perform a pinch command as indicated by arrows 420 wherein a forefinger and thumb are moved in opposite directions toward one another. Upon detection of the pinch command, the mode changes from a single-image viewing mode to a filmstrip viewing mode as shown in FIG. 5. As the user performs the pinch command from FIG. 4, he/she can continue to pinch to interactively modify the sizing of the filmstrip. As a result, conversion to the filmstrip viewing mode and resizing can be made in a single pinch command.

Continuing with FIG. 5, the filmstrip mode includes a filmstrip 502 including multiple independent images 504, 506, and 508. Although only one row of images is shown, the filmstrip view can include multiple rows displayed simultaneously to form an array of images. After converting into the filmstrip viewing mode, the pinching motion continues to resize the images as indicated by arrows 520 and 522. Thus, the single pinching motion can have the dual effect of changing modes and resizing the images. Reduction in the size of the images allows more images to fit in the viewing area 524. Consequently, the user can view a larger number of photos at the same time, allowing navigation and scrolling speed to increase. Once the resizing is completed, the user can perform a flick command to scroll the images.

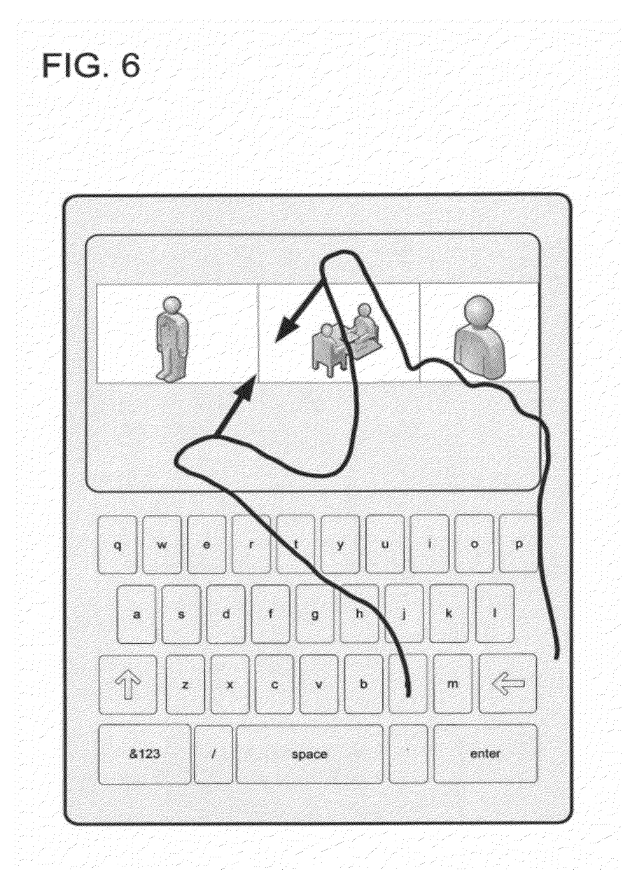

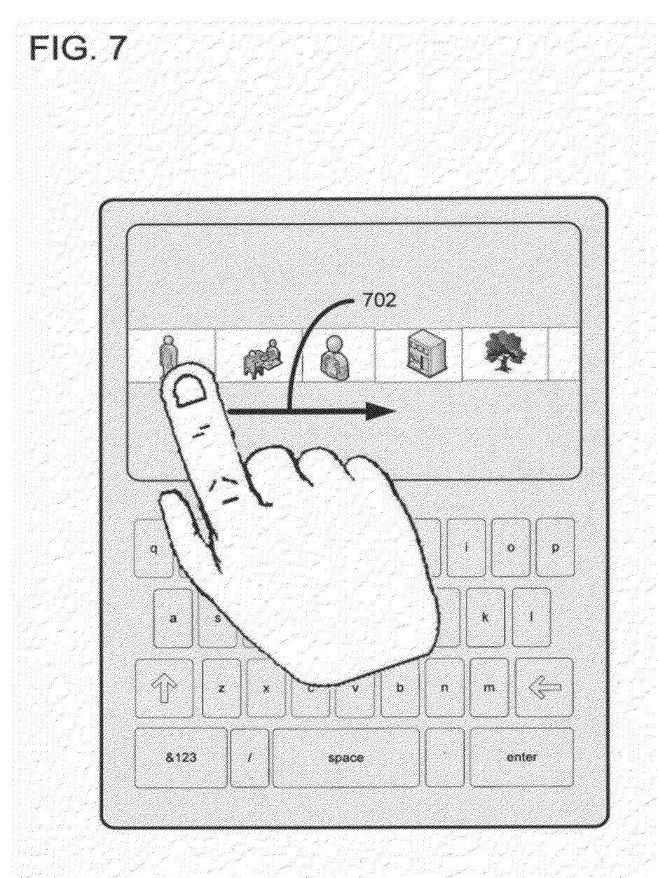

FIG. 6 shows that after the filmstrip mode is entered, the user can, at any time, dynamically resize the filmstrip. For example, the user can further pinch the filmstrip to reduce the images, which results in additional images being able to fit in the viewing area, as shown in FIG. 7. After the resizing, the user can use a flick command to scroll the images by dragging a finger across the touch screen as shown by arrow 702 (FIG. 7). Although the resizing in FIGS. 6 and 7 is shown as a reduction, the user can instead perform an expand command wherein the filmstrip is enlarged rather than reduced. The expand command is the opposite motion of the pinch command and indicates a desire to enlarge the images.

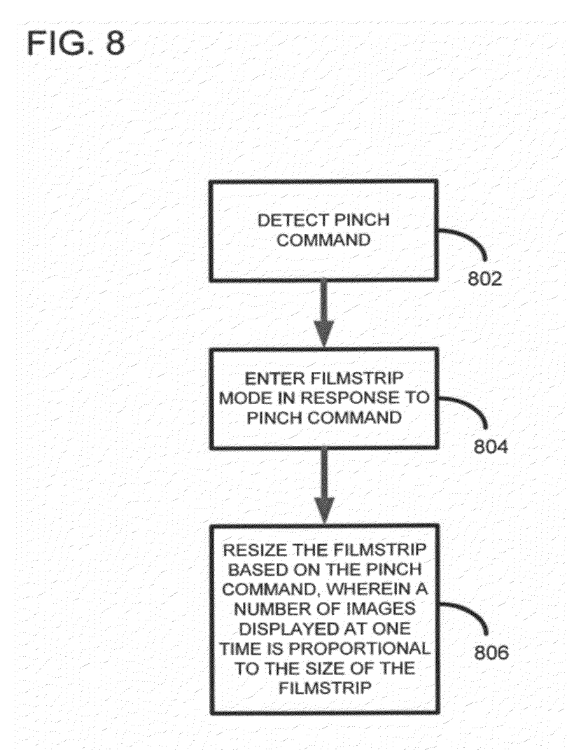

FIG. 8 is a flowchart of an embodiment for entering a filmstrip mode and resizing the images. In process block 802, a pinch command is detected while in a single-image viewing mode. In process block 804, a filmstrip viewing mode is entered in response to the detection of the pinch command. In process block 806, the filmstrip is resized in response to continued application of the pinch command. The number of images displayed in the viewing area is also dynamically changed as the filmstrip is reduced in size. Thus, using a single pinch command, the user can change modes of operation, control the size of the filmstrip, and add images to the viewable area.

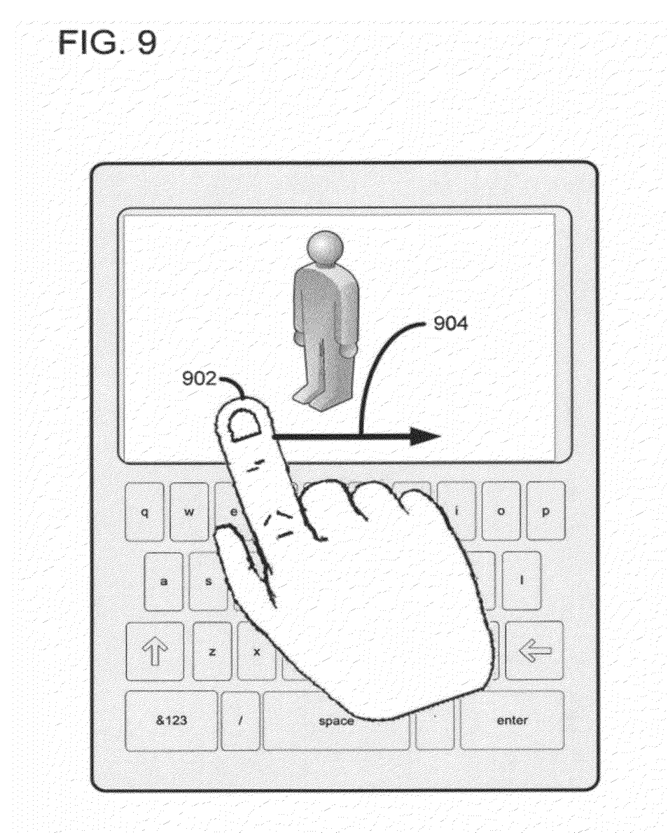

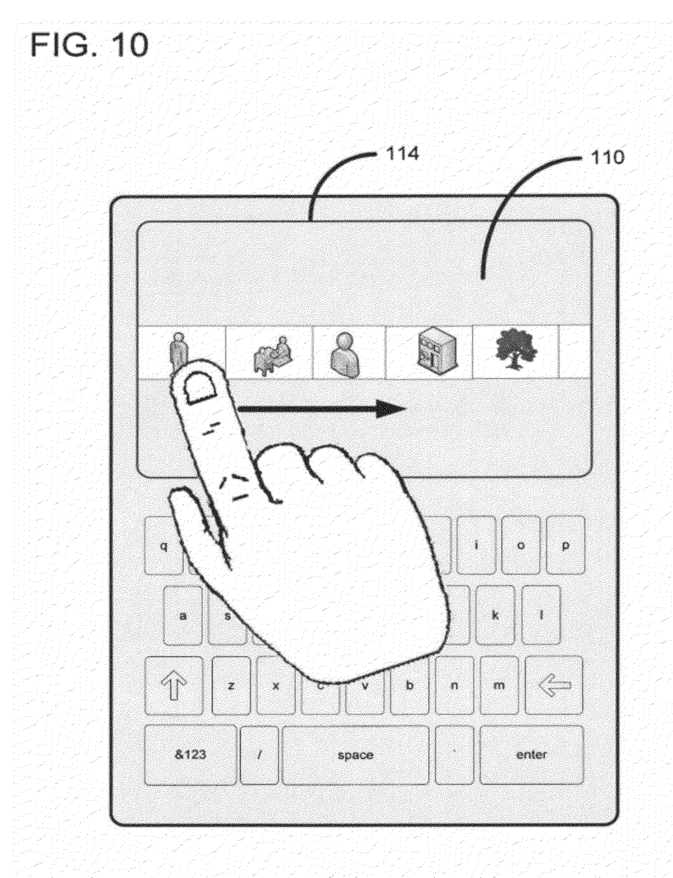

FIGS. 9 and 10 show another embodiment where a flick command is used to enter a filmstrip viewing mode. FIG. 9 shows the user interface in a single-image viewing mode. A user performs a flick command as shown by moving finger 902 in a direction shown by arrow 904, for example. A determination can be made on the speed of the flick command. If the speed exceeds a predetermined threshold, a filmstrip viewing mode can be entered as shown in FIG. 10. If the speed is below the predetermined threshold, then the single-image viewing mode is maintained and it simply displays the next image. The size of the filmstrip in the filmstrip view is directly dependent on the speed associated with the flick command.

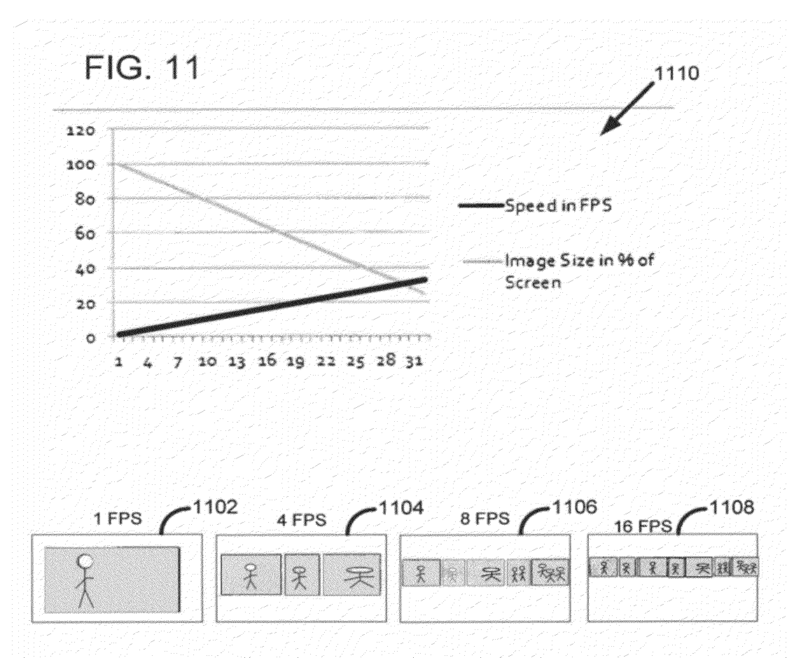

FIG. 11 shows an example of the image size association with speed. As shown at 1102, if the speed is 1 frame per second (FPS), the single-image viewing mode is maintained. Once the FPS equals or exceeds 4 FPS, the filmstrip viewing mode is automatically entered as shown at 1104. As the FPS increases, the size of the filmstrip is automatically and dynamically reduced so as to have a smaller size per image in the filmstrip and more images viewable at one time. As shown at 1106, at 8 FPS more images are visible than at 4 FPS. Likewise, at 16 FPS, even more images are viewable as shown at 1108. An exemplary graph is shown at 1110 illustrating that the speed and image size are inversely proportional. As the speed increases, the image size is reduced.

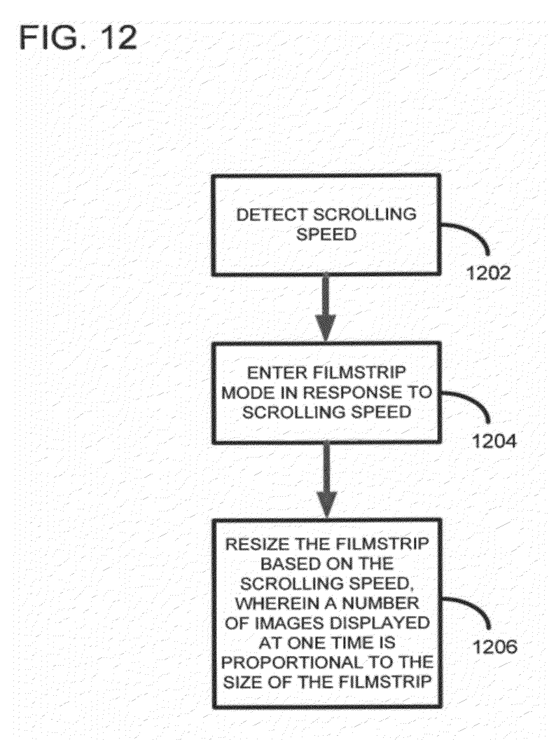

FIG. 12 is a flowchart of a method for entering a filmstrip viewing mode and changing size based on scrolling speed. In process block 1202, a scrolling speed is detected. As discussed further below, a touch screen interface can be used for detecting and calculating the scrolling speed. In process block 1204, if the scrolling speed exceeds a predetermined threshold, a filmstrip mode is automatically entered. In process block 1206, the filmstrip is continuously resized based on the current scrolling speed. Additionally, the number of images displayed is proportional to the size of the filmstrip. The faster the scrolling speed, the smaller the images. As the scrolling speed slows, the image size is increased. Once scrolling stops, the viewer can be returned to the single-image viewing mode. Additionally, at any time, the user can single tap a scrolling filmstrip in order to stop the scrolling. An additional tap can be used to select and open an image.

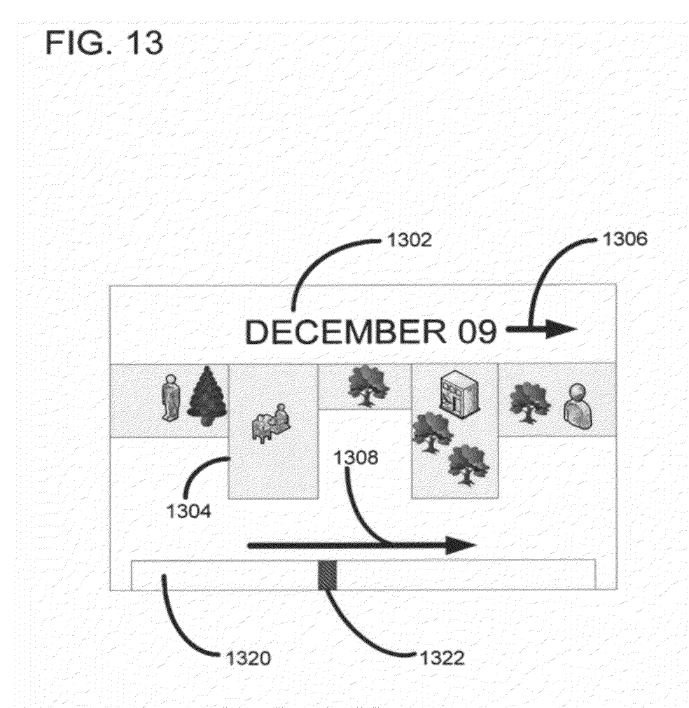

FIG. 13 shows that a date marker can be associated with the filmstrip viewing mode. The date marker 1302 shows a date (e.g., month and year) associated with the group of photos in the viewable area. Once a photo from a different month comes into view, the current date marker scrolls off the viewable area and a new date marker scrolls into the viewable area. In order to achieve this effect, the date marker 1302 scrolls at a different speed than the filmstrip 1304 as indicated by the lengths of arrows 1306, 1308. Specifically, the date marker 1302 scrolls at a slower speed than the filmstrip 1304. The scrolling speed of the date marker 1302 is related to the number of photos in the collection that have the same date. Thus, the speed is coordinated such that when the last photo associated with the date marker is scrolled through the viewing area, the date marker also scrolls off the viewing area and a new date marker scrolls into view. A reference indicator can be used to indicate current relative position through a collection of images. For example, a bar 1320 across the bottom or along side of the filmstrip can be used, wherein the width of the filmstrip represents the full size of the collection and hence the width of the bar. An indicator 1322 can also be used to move along the bar as the user flicks through the collection.

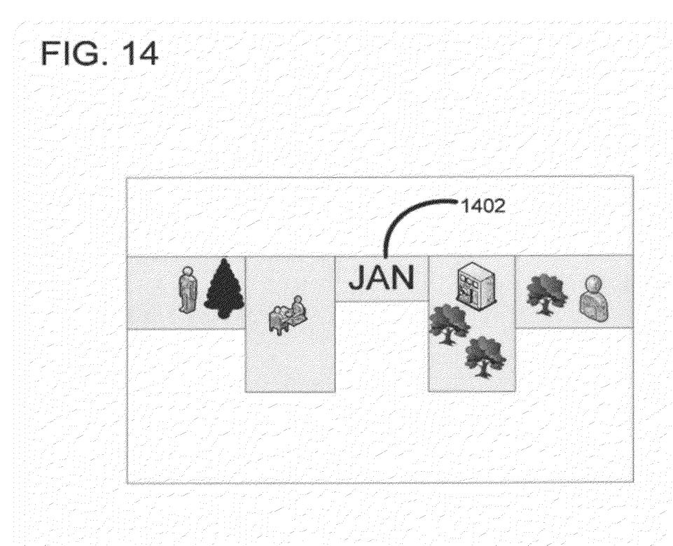

FIG. 14 shows another variation wherein a date marker 1402 is integrated directly into the filmstrip view. Specifically, the date marker is automatically inserted in place of an image so that the date marker becomes an integral part of the filmstrip

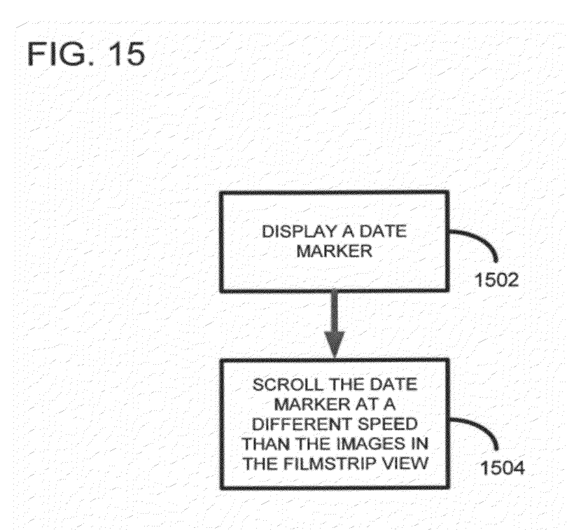

FIG. 15 is a flowchart of a method associated with displaying date markers in a filmstrip viewing mode. In process block 1502, a date marker is displayed in a filmstrip view. In process block 1504, the date marker is scrolled at a different speed than the images in the filmstrip view. Nonetheless, the user has control of the speed of both the date marker and the filmstrip using a single command, such as a flick command. Specifically, the faster the user flicks, both the date marker and the filmstrip scroll faster.

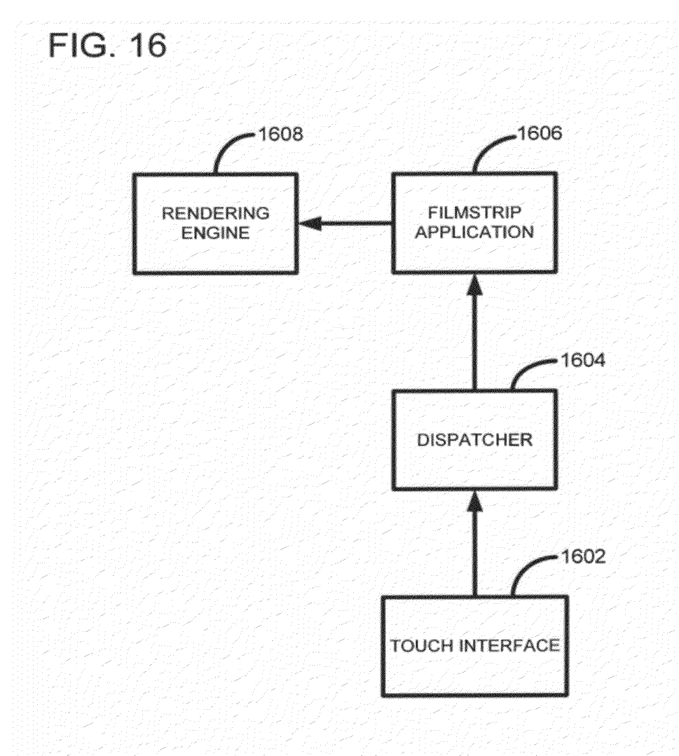

FIG. 16 is a system diagram showing an embodiment of how different system components can work interrelatedly in order to implement the embodiments herein. A touch interface 1602 can be used to detect touch gestures on the user interface. Flick speed can also be calculated based on the touch gestures. The touch gesture information and flick speed can be passed to a dispatcher 1604, which has requests from different applications for information when available. A filmstrip application 1606 receives the touch gesture and flick speed information from the dispatcher. Using the embodiments described herein, the filmstrip application 1606 uses a current state of the user interface plus the touch gesture and flick speed information from the dispatcher to render the information using a rendering engine 1608.

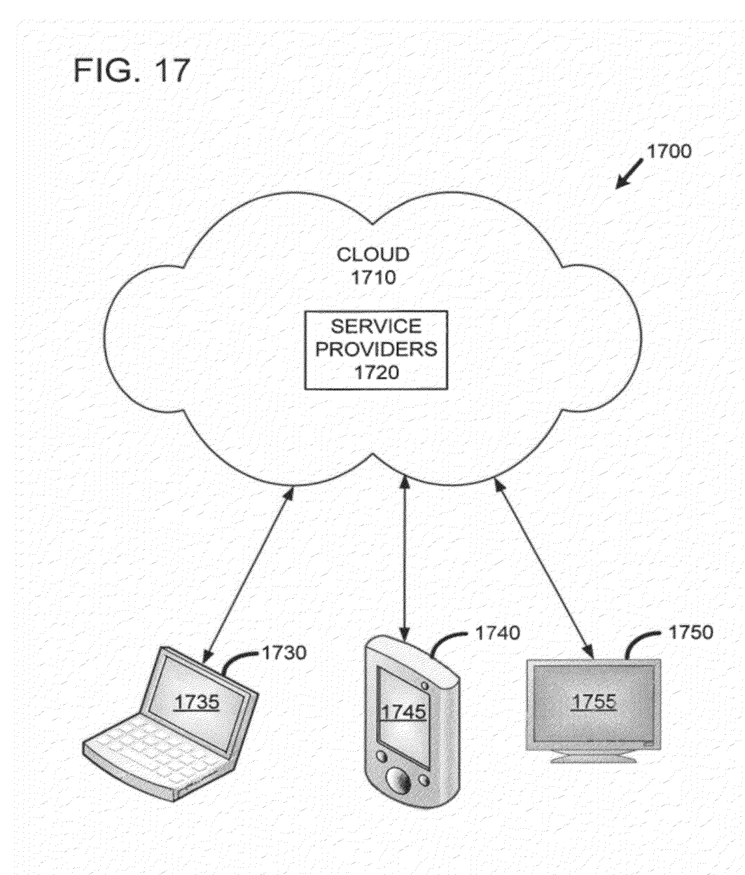

FIG. 17 illustrates a generalized example of a suitable implementation environment 1700 in which described embodiments, techniques, and technologies may be implemented.

In example environment 1700, various types of services (e.g., computing services) are provided by a cloud 1710. For example, the cloud 1710 can comprise a collection of computing devices, which may be located centrally or distributed, that provide cloud-based services to various types of users and devices connected via a network such as the Internet. The implementation environment 1700 can be used in different ways to accomplish computing tasks. For example, some tasks (e.g., processing user input and presenting a user interface) can be performed on local computing devices (e.g., connected devices 1730, 1740, 1750) while other tasks (e.g., storage of data to be used in subsequent processing) can be performed in the cloud 1710.

In example environment 1700, the cloud 1710 provides services for connected devices 1730, 1740 1750 with a variety of screen capabilities. Connected device 1730 represents a device with a computer screen 1735 (e.g., a mid-size screen). For example, connected device 1730 could be a personal computer such as desktop computer, laptop, notebook, netbook, or the like. Connected device 1740 represents a device with a mobile device screen 1745 (e.g., a small size screen). For example, connected device 1740 could be a mobile phone, smart phone, personal digital assistant, tablet computer, and the like. Connected device 1750 represents a device with a large screen 1755. For example, connected device 1750 could be a television screen (e.g., a smart television) or another device connected to a television (e.g., a set-top box or gaming console) or the like. One or more of the connected devices 1730, 1740, 1750 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1700. For example, the cloud 1710 can provide services for one or more computers (e.g., server computers) without displays.

Services can be provided by the cloud 1710 through service providers 1720, or through other providers of online services (not depicted). For example, cloud services can be customized to the screen size, display capability, and/or touch screen capability of a particular connected device (e.g., connected devices 1730, 1740, 1750).

In example environment 1700, the cloud 1710 provides the technologies and solutions described herein to the various connected devices 1730, 1740, 1750 using, at least in part, the service providers 1720. For example, the service providers 1720 can provide a centralized solution for various cloud-based services. The service providers 1720 can manage service subscriptions for users and/or devices (e.g., for the connected devices 1730, 1740, 1750 and/or their respective users). The resizable filmstrip view can be implemented on any one of these devices and images can be downloaded from the cloud.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of viewing multiple images, comprising:
entering a filmstrip viewing mode in which multiple images are displayed simultaneously;
in response to user input, resizing the multiple images in the filmstrip viewing mode;
scrolling the multiple images while maintaining the resizing.

2. The method of claim 1, wherein entering the filmstrip viewing mode is in response to detection of a user pinch command where at least two fingers are moved towards each other simultaneously.

3. The method of claim 2, wherein an extent of the resizing is controlled in response to the pinch command.

4. The method of claim 1, wherein the entering the filmstrip viewing mode is in response to a speed of scrolling.

5. The method of claim 1, wherein an extent of the resizing is proportional to a scrolling speed.

6. The method of claim 1, further including automatically inserting date markers in the filmstrip view.

7. The method of claim 1, further including stopping the scrolling in response to receiving a first tap input.

8. The method of claim 7, further including opening one of the images, independent of the other images, in response to a second tap input.

9. The method of claim 6, wherein the date markers scroll at a different speed than the images scroll.

10. The method of claim 1, wherein resizing includes reducing dimensions of the multiple images and adding new images into the viewable area.

11. A method of displaying a filmstrip view of images, comprising:
providing a filmstrip view including multiple independently selectable images simultaneously displayed in a viewing area of a touch screen;
resizing the multiple independently selectable images as a group in the filmstrip view so as to be able to fit more images in the viewing area.

12. The method of claim 11, further including entering the filmstrip view when in a single-image viewing mode in response to detection of a user pinch command where at least two fingers are moved towards each other simultaneously.

13. The method of claim 11, wherein the resizing is controlled in response to a user command or a number of images included in a collection.

14. The method of claim 11, wherein providing the filmstrip view includes rendering multiple independent images on a touch screen of a mobile phone.

15. The method of claim 11, further including scrolling the filmstrip view and wherein resizing is proportional to a scrolling speed.

16. The method of claim 11, further including automatically inserting date markers in the filmstrip view.

17. The method of claim 15, further including stopping the scrolling in response to receiving a single tap input.

18. The method of claim 17, further including opening an image in response to a second tap input.

19. The method of claim 16, wherein the date markers scroll at a different speed than the images scroll and further including a reference indicator showing current location relative to a collection of the images.

20. A method for viewing multiple photos, comprising:
displaying photos in a single-image viewing mode;
detecting a scroll command on a touch screen;
in response to the detecting, calculating a speed associated with the scroll command;
if the speed exceeds a predetermined threshold, enter a filmstrip viewing mode where multiple images are simultaneously displayed;
monitor the scrolling speed; and
dynamically resizing the multiple images based on the scrolling speed.
